(19) United States
(12) Patent Application Publication
(10) Pub. No.: US 2003/0068115 A1
(43) Pub. Date: Apr. 10, 2003

(54) Optical channel determination

(75) Inventor: Joseph Alan Barnard, London (GB)

Correspondence Address: SUGHRUE MION, PLLC, 2100 PENNSYLVANIA AVENUE, N.W., WASHINGTON, DC, 20037, US

(73) Assignee: BOOKHAM TECHNOLOGY, PLC.

(21) Appl. No.: 10/252,583

(22) Filed: Sep. 24, 2002

(30) Foreign Application Priority Data
Sep. 27, 2001 (GB) 0123291.7

(51) Int. Cl. G02B 6/34; G02B 6/26

(52) U.S. Cl. 385/14; 385/37; 385/140

(57) ABSTRACT

A system for detecting an optical output at a predetermined frequency, the system comprising: a plurality of optical guides for introducing an optical signal at said frequency into an input end of a dispersive optical component at each of a plurality of introduction sites corresponding to said optical guides; a detector located at the output end of the dispersive optical component and arranged to detect the optical power level of the optical signal introduced at each introduction site; means for establishing an optical power profile by interpolation of the optical power levels; and selection means for selecting the input optical guide at the introduction site at which the generated optical power level is spatially closest to the peak of the optical power profile.

### FIELD OF THE INVENTION

The present invention relates to optical channel determination, and in particular to a method and system for detecting an optical output at a predetermined frequency.

### BACKGROUND OF THE INVENTION

Many integrated optical devices are known, including in particular dense frequency division multiplexing (DFDM) or dense wavelength division multiplexing (DWDM) optical communications systems. In such systems, each optical carrier signal is at a frequency typically spaced on or near an ITU (International Telecommunications Union) grid by 100 GHz from its neighbours. Each optical carrier signal defines an optical channel in the communications system. One such optical communications system comprises a dispersive optical component in the form of an array waveguide grating. It will be appreciated however that the techniques discussed in the following can be used in other types of dispersive optical components.

According to the operation of such a device, a plurality of multiplexed optical channels may be input to the array waveguide grating on the chip. The grating operates to disperse or separate the optical channels to provide a plurality of outputs, each representing a single optical channel. These outputs are picked up by photodiodes or other suitable detectors located at the edge of the chip at spaced locations.

A problem that arises is that real optical sources generate carrier signals at frequencies which deviate from the desired grid frequencies. It has been determined that a deviation of up to !10% is possible. This means that photodiodes which are located to pick up frequencies on the ITU grid, may in fact be picking up signals which are not the peak signals of the channels which they are designed to detect. This means that the operation of the optical device is not optimised, and in some cases significant errors can result. It is desirable to provide a system which allows optical channels to be detected as close to their peak actual frequency as realistically possible. One way of doing this is to provide more than one detector for each channel, and to process the signals from the multiple detectors. This however requires a greater density of detectors than can sometimes be physically provided on-chip.

An alternative solution is offered by the present invention.

### SUMMARY OF THE INVENTION

According to one aspect of the present invention there is provided a method of detecting an optical output at a predetermined frequency, the method comprising: introducing an optical signal at said frequency into an input end of a dispersive optical component at each of a plurality of introduction sites; for each introduction site, detecting the optical power level at a fixed output location at the output end of the dispersive optical component; establishing an optical power profile by interpolation of the optical power levels; and selecting the introduction site at which the generated optical power level is spatially closest to the peak of the optical power profile.

According to another aspect of the invention there is provided a system for detecting an optical output at a predetermined frequency, the system comprising: a plurality of optical guides for introducing an optical signal at said frequency into an input end of a dispersive optical component at each of a plurality of introduction sites corresponding to said optical guides; a detector located at the output end of the dispersive optical component and arranged to detect the optical power level of the optical signal introduced at each introduction site; means for establishing an optical power profile by interpolation of the optical power levels; and selection means for selecting the input optical guide at the introduction site at which the generated optical power level is spatially closest to the peak of the optical power profile.

According to a further aspect of the invention there is provided a multi-chip module comprising: an integrated optics chip comprising a dispersive optical component having at least one input waveguide, the input waveguide providing a plurality of selectable launch sites for introducing an optical signal at a predetermined frequency into an input end of the dispersive optical component and a detector located at the output end of the dispersive optical component and arranged to detect the optical power level of the optical signal introduced at each launch site; and a processing chip comprising means for establishing an optical power profile by interpolation of the optical power levels and selection means for selecting the launch site at which the generated optical power level is spatially closest to the peak of the optical power profile.

### BRIEF DESCRIPTION OF THE DRAWINGS

For a better understanding of the present invention and to show how the same may be carried into effect reference will now be made by way of example to the accompanying drawings in which:

FIG. 1 is a diagram of a dispersive optical device in the form of an array waveguide;

FIG. 2 is a signal spectrum diagram of three optical channels;

FIG. 3 is a schematic diagram illustrating a plurality of launch waveguides associated with an input waveguide;

FIG. 4 is a schematic cross-section illustrating two sets of launch waveguides;

FIG. 5 is a graph of power versus frequency for one optical channel; and

FIG. 6 is a schematic block diagram of a multi-chip module.

### DESCRIPTION OF A PREFERRED EMBODIMENT

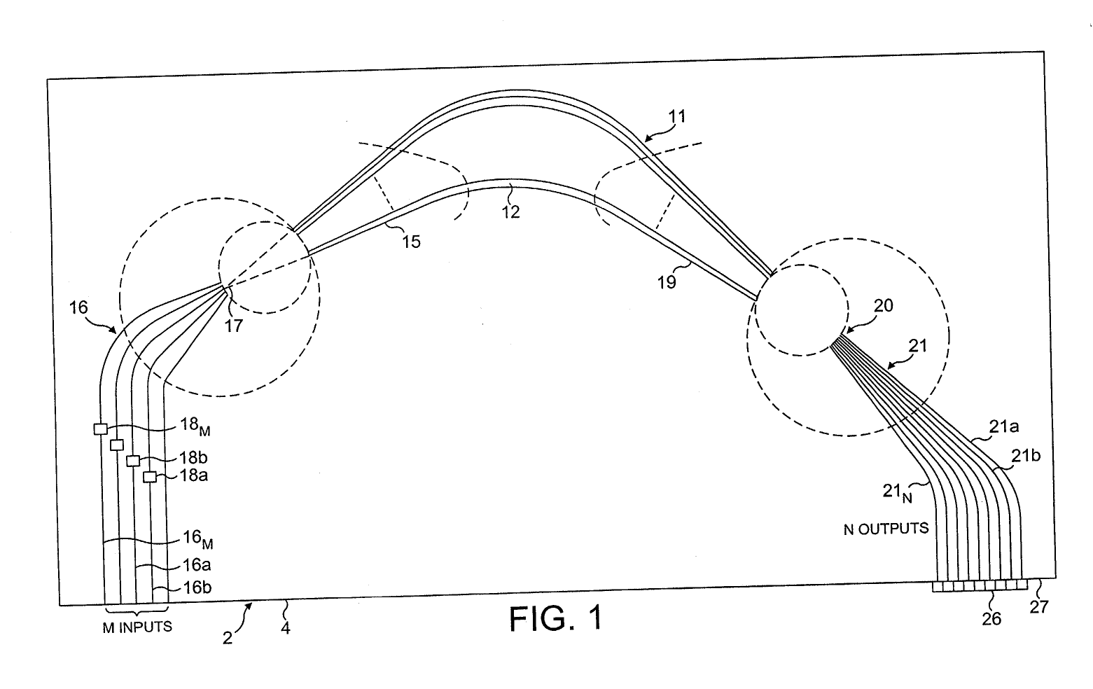

FIG. 1 illustrates an optical device integrated on a chip 2 of the type known as a dense wavelength division multiplexer (or equivalent dense frequency division multiplexer). The chip boundary is denoted by reference numeral 4. In the chip 2 shown in FIG. 1 a dispersive waveguide array 11 consists of a plurality of curved waveguides 12. The demultiplexer is formed as an integrated chip on a planar substrate. The substrate may be formed with silicon-on-insulator and the waveguides may be ridge waveguides of the type shown in U.S. Pat. No. 5,757,986. The array 11 is a dispersive array of ridge waveguides formed on the chip 2. Each of the waveguides has a straight input section 15 and a straight output section 19 (although the existence of such straight sections is not essential). In this case, the input and output ends of the array 11 are symmetrical. The straight input sections 15 incline inwards towards each other so as to point to the focus position 17 at the end of an input waveguide. The input waveguide is selected from the group of input waveguides labelled M inputs in FIG. 1. Each waveguide is referenced respectively 16ₐ, 16_{b} . . . 16_{M}. The input waveguide is selected from the group of input waveguides using the associated input selector switch 18ₐ, 18_{b} . . . 18_{M}.

Similarly, the straight output sections 19 are inclined towards each other so as to form a focusing region 20 adjacent the entrance to an array of N output waveguides 21. The individual output waveguides are labelled respectively 21ₐ . . . 21_{N}. The array of output waveguides 21 detect images received from the dispersive waveguide array 11 and transmit the optical signals to spaced locations at the edge 27 of the chip where they are detected by an array of photodiodes 26. In the chip of FIG. 1, the output of each waveguide is received by a respective photodiode.

For an input light source supplied via the input waveguides 16 comprising a plurality of optical channels at respective carrier frequencies, the waveguide array 11 acts to disperse these optical channels such that respective optical channels are picked up by respective output waveguides 21ₐ . . . 21_{N} of the output waveguide array 21. For existing optical systems, the carrier frequencies lie on a so-called ITU (International Telecommunications Union) grid, with each carrier frequency being separated by 100 GHz from its neighbours. The ITU grid spans a range from 191 to 196 THz.

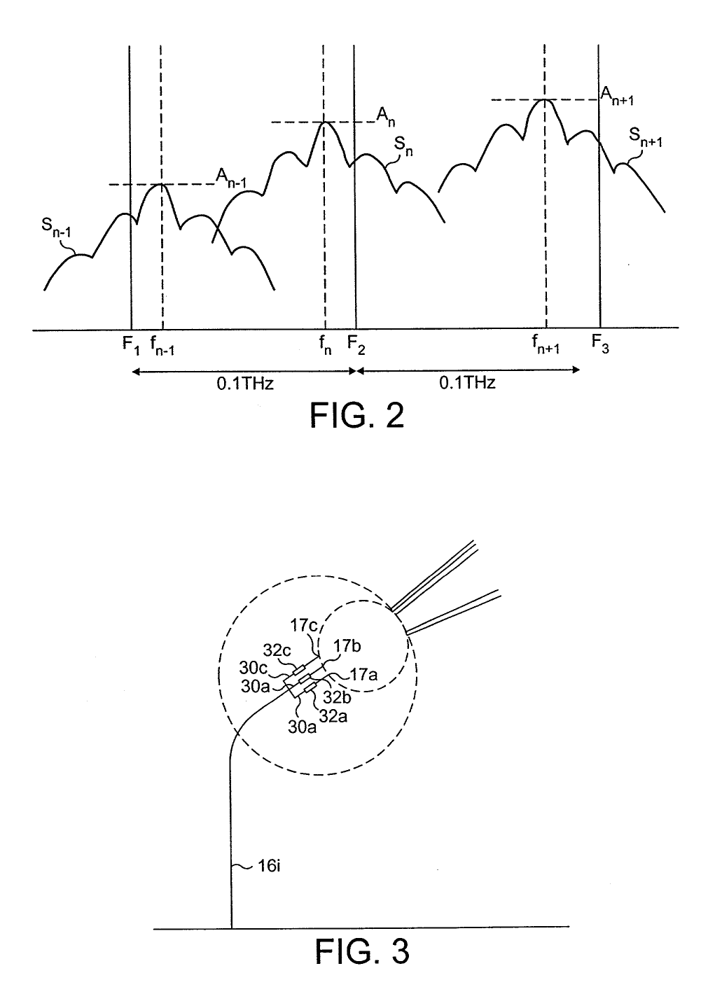

In an ideal world, each of the photodiodes of the photodiode array 26 would pick up one such carrier frequency and thus be able to provide an electrical output representing the power level of that optical channel. In reality, a number of factors arise which mean that this ideal situation is not achieved in practice. Reference will now be made to FIG. 2 to explain some of these factors. FIG. 2 illustrates in bold vertical lines three frequencies F₁, F₂, F₃ from the ITU grid at 0.1 THz spacing. Three signals Sₙ₋₁, Sₙ, Sₙ₊₁ are also illustrated which represent the optical signals from each of three optical channels which are nominally located on the grid carrier frequencies F₁, F₂ and F₃. In reality it is frequently the case that the peak value A on an optical channel in fact lies on a frequency somewhat displaced from its nominal frequency. In FIG. 2, the peak value Aₙ₋₁ lies at a frequency fₙ₋₁ (displaced from F₁), the peak value Aₙ of the signal Sₙ lies at a frequency fₙ displaced from F₂, and the peak value Aₙ₊₁ of the signal Sₙ₊₁ lies at a frequency fₙ₊₁ displaced from F₃. It is possible to see also that the displacement is not necessarily a regular one, but that the peak could fall on either side of the nominal carrier frequency, within an error tolerance of ! 10%.

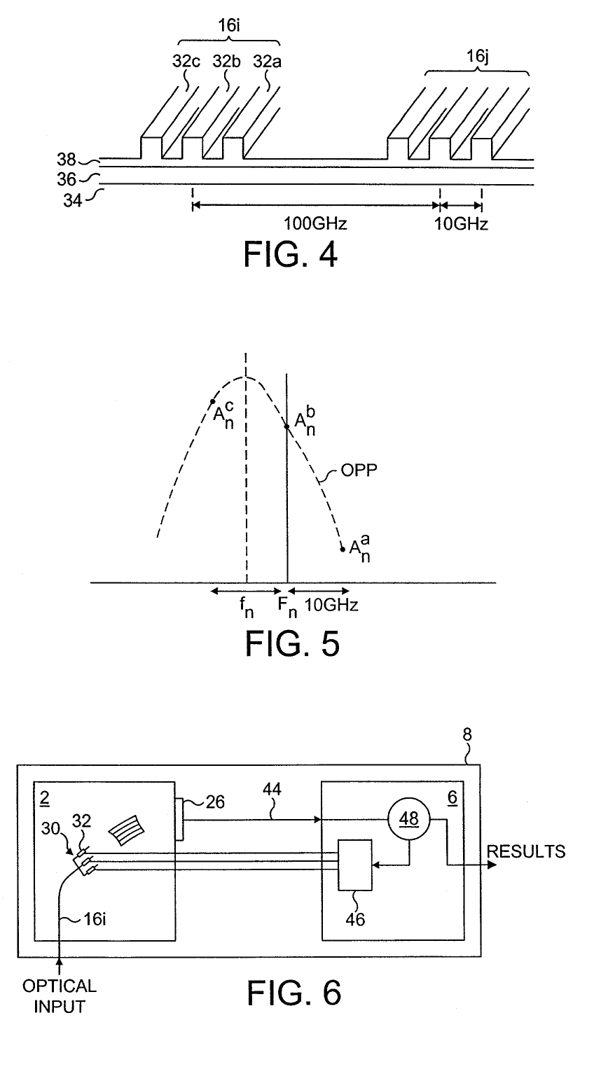

The result of the peak value frequency being displaced from the grid frequency is that there is a spatial dislocation which exhibits itself at the photodiodes of the photodiode array, such that a photodiode located to receive the grid frequency would instead receive a signal from the optical channel at a value displaced from its peak value. The system described in the following is intended to ensure that each optical channel is picked up by its associated photodiode as close to its peak signal as practically possible. FIG. 3 is a diagram illustrating part of the multiplexer of FIG. 1, modified in accordance with the present invention. Only a single input waveguide 16i is illustrated although it will readily be appreciated that the modification discussed herein can be applied to the plurality of M inputs as illustrated in FIG. 1. Thus, each input waveguide 16i branches into three launch waveguides 30a, 30b, 30c, each having associated with it a voltage controlled optical attenuator 32a, 32b, 32c. Each optical attenuator 32 is controlled by a control signal discussed in more detail in the following between an on state in which the optical path along that launch waveguide is closed, and an off state in which the optical path on that launch waveguide is open. By virtue of the three launch waveguides 30a, 30b, 30c, each input waveguide 16i thus provides three possible launch sites 17a, 17b, 17c, controllable through control of the optical attenuators 32. In use of the optical device, only one launch site is used. The selection of that launch site will be described in the following. Firstly, reference is made to FIG. 4 which is a sectional view through a silicon-on-insulator ridge waveguide structure which shows two groups of three launch waveguides. A silicon substrate 34 carries a layer of oxide 36 on which is a layer of epitaxial silicon 38. Ridge waveguides 32a, 32b and 32c are formed in the epitaxial silicon as discussed in U.S. Pat. No. 5,757,986 referred to above. Those ridge waveguides represent the launch waveguides for the input waveguides 16i. The three ridge waveguides on the right hand side represent the waveguides for the adjacent input waveguide 16j (not shown in FIG. 3, but shown in FIG. 1). The input waveguides 16i, 16j, are separated by a distance corresponding to the grid frequency separation of 100 GHz. The launch waveguides in each set of three are separated by a distance corresponding to the spatial separation incurred by the likely maximum grid error, that is 10 GHz in the described embodiment. The reason for this will become clearer in the following.

To select a launch site for each input waveguide, an optical signal is transmitted through the input waveguide 16i. Two of the voltage attenuators 32a, 32b are turned on, and one 32c is turned off. The signal at the photodiode of the photodiode array 26 associated with that optical channel is measured. Then, that attenuator 32c is turned on, the next attenuator 32b is turned off, the optical signal is relaunched and the signal at the photodiode measured again. This step is carried out a third time for the third launch waveguide. The result is shown in

FIG. 5, where Aₙ^{a} represents the power level of the signal measured when the optical signal is introduced along launch waveguide 32a. An interpolation algorithm is used to generate an optical power profile using the measurements Aₙ^{a}, Aₙ^{b} and Aₙ^{c}, this optical power profile being denoted by the dotted line OPP in FIG. 5. The peak of the optical power profile is located by the algorithm, to identify the frequency fₙ actually being detected. The launch waveguide which launched the signal closest to that peak is the one which is used in practice, in the described embodiment this would be 32c. Thus, in use of the chip, the attenuator 32c on launch waveguide 30c would be turned off, and the attenuators on the other two launch waveguides would be turned on.

FIG. 6 is a schematic block diagram of a multi-chip module 8 which contains an optical chip 2 as has already been described and a processor chip 6. The processor chip 6 receives electrical data 44 from the photodiode array 26 of the optical device 2 and operates to produce output data in the form of results for the chip. In addition, the processor chip 6 incorporates a selector 46 which selects the optical attenuators on the launch waveguides 30. The processor 6 runs a program 48 which receives the electrical power values 44 from the photodiodes 26, performs the interpolation to calculate the optical power profile OPP, establishes the peak power location and selects the launch site closest to that by operating the selector switch 46 which controls the optical attenuators 32.

The applicant draws attention to the fact that the present invention may include any feature or combination of features disclosed herein either implicitly or explicitly or any generalisation thereof, without limitation to the scope of any definitions set out above. In view of the foregoing description it will be evident to a person skilled in the art that various modifications may be made within the scope of the invention.

What is claimed is:

1. A method of detecting an optical output at a predetermined frequency, the method comprising:
introducing an optical signal at said frequency into an input end of a dispersive optical component at each of a plurality of introduction sites;
for each introduction site, detecting the optical power level at a fixed output location at the output end of the dispersive optical component;
establishing an optical power profile by interpolation of the optical power levels; and
selecting the introduction site at which the generated optical power level is spatially closest to the peak of the optical power profile.

2. A method according to claim 1, wherein the step of selecting the introduction site comprises controlling optical attenuators on launch waveguides defining respectively each of the plurality of introduction sites.

3. A system for detecting an optical output at a predetermined frequency, the system comprising:
a plurality of optical guides for introducing an optical signal at said frequency into an input end of a dispersive optical component at each of a plurality of introduction sites corresponding to said optical guides;
a detector located at the output end of the dispersive optical component and arranged to detect the optical power level of the optical signal introduced at each introduction site;
means for establishing an optical power profile by interpolation of the optical power levels; and
selection means for selecting the input optical guide at the introduction site at which the generated optical power level is spatially closest to the peak of the optical power profile.

4. A system according to claim 3, wherein the detector comprises a photodiode.

5. A system according to claim 3, wherein the dispersive optical component comprises an array waveguide.

6. A system according to claim 3, which comprises a plurality of input waveguides, each input waveguide being associated with a said plurality of optical guides.

7. A system according to claim 3, which comprises a plurality of output waveguides at the output end of the dispersive optical component, each output waveguide having a respective detector associated therewith.

8. A system according to claim 3, wherein the selection means comprises a selector switch for controlling a plurality of optical attenuators associated respectively with the plurality of optical guides.

9. A multi-chip module comprising:
an integrated optics chip comprising a dispersive optical component having at least one input waveguide, the input waveguide providing a plurality of selectable launch sites for introducing an optical signal at a predetermined frequency into an input end of the dispersive optical component and a detector located at the output end of the dispersive optical component and arranged to detect the optical power level of the optical signal introduced at each launch site; and
a processing chip comprising means for establishing an optical power profile by interpolation of the optical power levels and selection means for selecting the launch site at which the generated optical power level is spatially closest to the peak of the optical power profile.

10. A multi-chip module according to claim 9, wherein the selection means comprises a selector switch for controlling optical attenuators associated with each of the plurality of optical guides on the integrated optics device.
